(19) United States
(12) Patent Application Publication
(10) Pub. No.: US 2015/0282109 A1
(43) Pub. Date: Oct. 1, 2015

(54) METHODS AND SYSTEMS FOR SEAMLESS MIGRATION TO RADIO NETWORKS

(71) Applicant: MOTOROLA SOLUTIONS, INC, SCHAUMBURG, IL (US)

(72) Inventor: NICHOLAS M GUNDER, SOBORG (DK)

(73) Assignee: MOTOROLA SOLUTIONS, INC, SCHAUMBURG, IL (US)

(21) Appl. No.: 14/230,069

(22) Filed: Mar. 31, 2014

(51) Int. Cl. H04W 60/00; H04W 48/16

(52) U.S. Cl. CPC H04W 60/005; H04W 48/16

(57) ABSTRACT

A mobile radio has a default mode of operation according to which the mobile radio is homed on a first wireless network in unique association on the first wireless network with a first-wireless-network identifier. The mobile radio receives, while operating in the default mode, a radio set of multiple second-wireless-network identifiers. The radio set is associated with a second wireless network, and each identifier in the radio set is reserved for use on the second wireless network by mobile radios that are not homed on the second wireless network. The mobile radio selects an identifier from the radio set and registers on the second wireless network using the selected identifier. The mobile radio operates in a migrating mode of operation according to which the mobile radio is homed on the second wireless network in unique association on the second wireless network with the selected identifier.

### BACKGROUND OF THE INVENTION

Wireless-communication devices (hereinafter “mobile radios”) such as cell phones, smart phones, and mobile WiFi hotspots are generally configured with the ability to obtain one or more types of wireless service. Such service could take the form of telephony service and/or data service (e.g., Internet connectivity), among other forms of service. These services are typically obtained via a wireless network. Well known examples of such wireless networks include Global System for Mobile Communications (GSM) networks, CDMA2000 networks, and Long Term Evolution (LTE) networks, among numerous other examples.

In order to obtain wireless service via a wireless network, a mobile radio must typically register with the wireless network. Registration usually involves the wireless network authenticating the mobile radio and determining whether the mobile radio is authorized to obtain wireless service via the wireless network. Authorization may involve the wireless network determining that a user of the mobile radio is subscribed to one or more services provided by the wireless network, and/or that the user's account is in good standing.

A mobile radio is often “homed” with a given wireless network. As is generally known to those having skill in the relevant art, other equivalent expressions of this concept include “homed with,” “homed to,” and the like, and furthermore the network on which a given mobile radio is homed is often referred to as the “homed network” with respect to that mobile radio. The homed network may be, for example, the network for use of which the user of the mobile radio pays, and is sometimes the network via which the mobile radio is configured to prefer to obtain wireless service. The homed network is often (though not always) indicated by a unique identifier assigned to the mobile radio.

The identifier may be used by a wireless network (not necessarily the homed network) to determine whether to allow the mobile radio to register with the wireless network. For example, when attempting to register with a wireless network, a mobile radio may provide the identifier to the wireless network. If the provided identifier matches one of a set of identifiers that are associated with the given wireless network, then the wireless network might retrieve a device profile from a database within the wireless network so as to determine whether the mobile radio is authorized to register with the wireless network. If, for example, the profile indicates that the mobile-radio account is in good standing (e.g., no outstanding invoices), then the wireless network may allow the mobile radio to register. If the provided identifier does not match any identifier associated with the wireless network, then the wireless network may query a database to determine whether a roaming agreement exists between that wireless network and the homed network indicated by the identifier.

If a roaming agreement exists between the given wireless network and the homed network, then the given wireless network may allow the mobile radio to register. If, however, no roaming agreement exists, or if infrastructure is missing that is necessary to facilitate roaming from the homed network to the given wireless network, then the mobile radio, upon attempting to register with the given wireless network using the identifier assigned to the mobile radio, may be prevented from registering with the wireless network.

### BRIEF DESCRIPTION OF THE SEVERAL VIEWS OF THE DRAWINGS

The accompanying figures, where like reference numerals refer to identical or functionally similar elements, together with the detailed description below, are incorporated in and form part of the specification, and serve to further illustrate embodiments of the following claims, and explain various principles and advantages of those embodiments.

FIG. 1 depicts an example communication system in which various embodiments may be used.

FIG. 2 depicts an example wireless network via which one or more mobile radios can communicate, in accordance with various embodiments.

FIG. 3 depicts an example mobile radio, in accordance with various embodiments.

FIG. 4 depicts an example wireless-network identifier, in accordance with various embodiments.

FIGS. 5 and 6 depict respective example radio sets of wireless-network identifiers, in accordance with various embodiments.

FIG. 7 depicts an example method, in accordance with various embodiments.

FIG. 8 depicts various possible locations of a database within a communication system, in accordance with various embodiments.

Those having skill in the relevant art will appreciate that elements in the figures are illustrated for simplicity and clarity, and have not necessarily been drawn to scale. For example, the dimensions of some of the elements in the figures may be exaggerated relative to other elements to help to improve understanding of various embodiments. Furthermore, the apparatus and method components have been represented where appropriate by conventional symbols in the figures, showing only those specific details that are pertinent to understanding the disclosed embodiments so as not to obscure the disclosure with details that will be readily apparent to those having skill in the relevant art having the benefit of this description.

### DETAILED DESCRIPTION OF THE INVENTION

Disclosed herein are embodiments of a method and system carried out by a mobile radio having a default mode of operation according to which the mobile radio is homed on a first wireless network in unique association on the first wireless network with a first-wireless-network identifier. The mobile radio receives, while operating in the default mode, a second-wireless-network radio set of multiple second-wireless-network identifiers. The second-wireless-network radio set is associated with a second wireless network, and each second-wireless-network identifier in the second-wireless-network radio set is reserved for use on the second wireless network by mobile radios that are not homed on the second wireless network. The mobile radio selects a given second-wireless-network identifier from among the multiple second-wireless-network identifiers in the second-wireless-network radio set and registers on the second wireless network using the given second-wireless-network identifier. The mobile radio operates in a migrating mode of operation according to which the mobile radio is homed on the second wireless network in unique association on the second wireless network with the given second-wireless-network identifier.

The above overview is intended to be illustrative and not limiting. Moreover, the presently disclosed methods and systems will be more readily understood in light of the drawings and their accompanying descriptions, which again are provided by way of illustration and example explanation, not by way of limitation.

### I. EXAMPLE COMMUNICATION SYSTEM

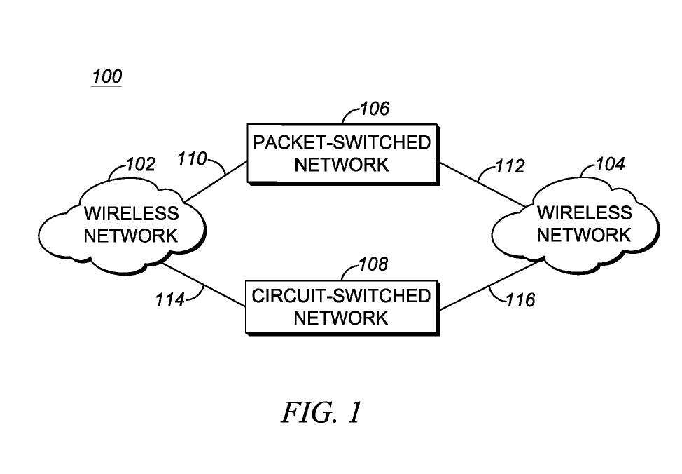

FIG. 1 depicts an example communication system in which various embodiments may be used. As shown, communication system 100 includes respective wireless networks 102 and 104, a packet-switched network (PSN) 106, and a circuit-switched network (CSN) 108. Wireless networks 102 and 104 are connected to PSN 106 by respective communication links 110 and 112, and to CSN 108 by respective communication links 114 and 116. Those having skill in the art will appreciate that additional and/or different entities may be present in communication system 100.

Wireless networks 102 and 104 could be any wireless networks equipped and configured by those of skill in the relevant art to function as described herein. In addition to the GSM, CDMA2000, LTE networks described above, one or both of wireless networks 102 and 104 could take the form of a TErrestrial Trunked RAdio (TETRA) network, an IEEE 802.11 (WiFi) network, and/or a Bluetooth personal-area network, among other possibilities.

The coverage area of wireless network 102 could, though needn't necessarily, partially or completely overlap the coverage area of the wireless network 104. The respective coverage areas could operate in similar (or identical) geographic areas, and/or could operate in disparate geographic areas—for example, in different cities, counties, or states. In an embodiment, wireless network 102 operates in a first country and wireless network 104 operates in a second country. Those having skill in the art will appreciate that different arrangements are possible as well.

PSN 106 could be the worldwide network typically referred to as the Internet, but could just as well be any other packet-switched network equipped and configured by those of skill in the relevant art to function as described herein. Nodes resident on PSN 106 may be Internet Protocol (IP) nodes and may be addressed using IP addresses, as examples. CSN 108 could be the circuit-switched communication network typically referred to as the Public Switched Telephone Network (PSTN), but could just as well be any other circuit-switched network arranged and configured by those of skill in the relevant art to function as described herein.

Any one or more of communication links 110 through 116 could include one or more communication devices, nodes, networks, connections, switches, bridges, routers, and the like. Any or all of communication links 110 through 116 could make use of wired and/or wireless forms of communication. One or more communication links instead of and/or in addition to communication links 110 through 116 could be present. As one example, there could be one or more communication links between PSN 106 and CSN 108.

### II. EXAMPLE WIRELESS NETWORK

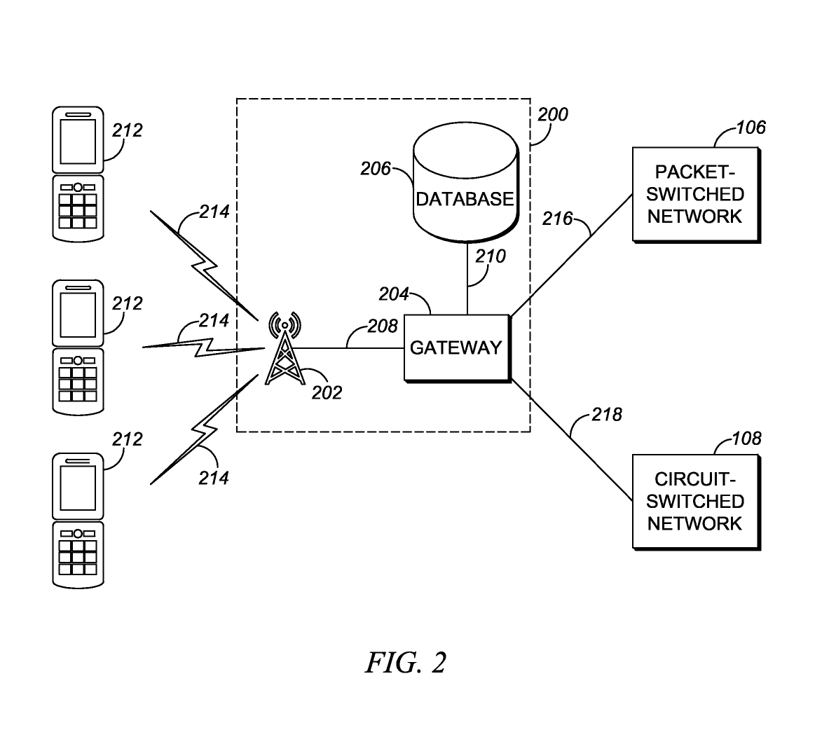

FIG. 2 depicts an example wireless network via which one or more mobile radios can communicate, in accordance with various embodiments. As shown in FIG. 2, wireless network 200 includes a base station 202, a gateway 204, and a database 206. One or more mobile radios 212 may be engaged in wireless communication with network 200 via respective air interfaces 214. Base station 202 and database 206 are connected to gateway 204 via respective communication links 208 and 210. Either or both of wireless network 102 and 104 could take a form similar to wireless network 200.

Base station 202 may be any network-side entity that is suitably equipped and configured by those of skill in the relevant art to function as described herein, which in general is to provide wireless service to mobile radios (such as mobile radios 212) over respective air interfaces (such as air interfaces 214). Base station 202 could take the form of a WiFi access point, a TETRA base station, a GSM/CDMA200 base transceiver station (BTS), and/or an LTE eNodeB, among numerous other examples. Moreover, while three mobile radios 212 and one base station 202 are depicted in FIG. 2, this is by way of illustration and not by way of limitation, as any number of either could be present in a given implementation.

Gateway 204 may be any entity configured to perform the gateway functions described herein, which may generally include relaying information among one or more mobile radios, base stations, databases, packet-switched networks, circuit-switched networks, and/or other entities present within and/or connected to network 200. Moreover, the gateway 204 may be configured as necessary to convert and/or translate between two or more different data types and/or communication protocols; for instance, the gateway 204 may be arranged to translate between one or more packet-switched data-communication protocols on the one hand and one or more circuit-switched data-communication protocols on the other hand; and certainly numerous other examples are possible as well. The database 206 might store, as examples, a list of identifiers of mobile radios that are homed to wireless network 102 and authorized to register with network 102, a list of identifiers homed to wireless network 104, subscription profiles (of respective users and/or devices, as examples), and/or other data related to the functioning of the wireless network. Furthermore, as the network 200 of FIG. 2 depicts a form that either or both of the networks 102 and 104 may take in various embodiments, database 206 in at least one embodiment stores identifiers usable by various mobile radios communicating via the network 200. And certainly other configurations could be used, as known to those having skill in the art.

Communication links 208, 210, 216, and 218 may take any suitable form, such as any of the forms described above in connection with links 110 through 116 of FIG. 1. Communication link 208 may function as what is known as a “backhaul” with respect to base station 202, as link 208 may enable gateway 204 to bridge (i) communications conducted by base station 202 with mobile radio 212 over air interfaces 214 with (ii) communications via the rest of wireless network 200 and beyond. One or more entities such as one or more network access servers (NAS) and/or Voice over IP (VoIP) gateways may reside on any one or more of the communication links to bridge the respective wireless networks to one or more PDNs or CDNs.

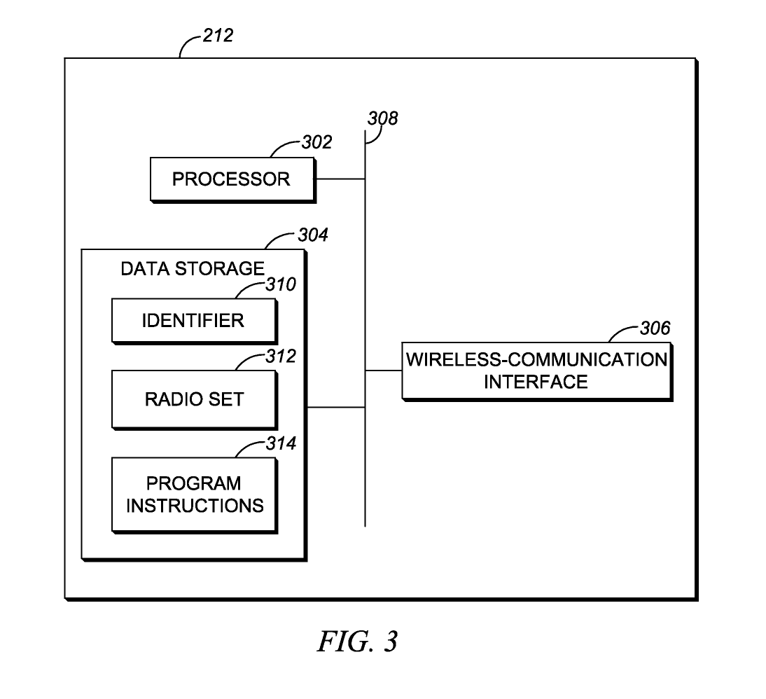

An example mobile radio is described more fully below in connection with FIG. 3, though in general mobile radio 212 may be any type of mobile radio or other wireless-communication device suitably equipped and configured by those of skill in the relevant art to function as described herein. Air interfaces 214 may be TETRA air interfaces having an uplink and a downlink, as known to those of skill in the relevant art, though air interfaces 214 may comply instead or in addition with one or more other protocols.

As known to those of skill in the relevant art, wireless network 200 may include additional and/or different entities deemed suitable to a given implementation by those of skill in the relevant art. Moreover, these entities may be configured and interconnected in any manner known to those of skill in the relevant art to provide wireless service to mobile radios via base stations and to bridge such wireless service with transport networks such as PSN 106 and CSN 108. In general, then, other configurations are possible, as those described herein are provided by way of example and not limitation.

### III. EXAMPLE MOBILE RADIO

FIG. 3 depicts an example mobile radio, in accordance with various embodiments. As illustrated, mobile radio 212 includes a processor 302, data storage 304, and a wireless-communication interface 306, all of which are communicatively linked by a system bus (or other suitable communication path) 308. It should be noted that this example architecture of mobile radio 212 is presented for illustration and not by way of limitation.

Processor 302 may include one or more processors of any type deemed suitable by those of skill in the relevant art, some examples including a general-purpose microprocessor, a dedicated digital signal processor (DSP), and a graphics processor. Data storage 304 may take the form of any non-transitory computer-readable medium or combination of such media, some examples including flash memory, read-only memory (ROM), and random-access memory (RAM) to name but a few, as any one or more types of non-transitory data-storage technology deemed suitable by those of skill in the relevant art could be used. In the embodiment that is depicted in FIG. 3, data storage 304 contains a wireless-network identifier 310, a wireless-network radio set 312 of wireless-network identifiers, and program instructions 314 executable by processor 302 for carrying out various combinations of the mobile-radio functions described herein. In general, data storage 304 may contain any one or more types of data deemed suitable by those of skill in the relevant art for carrying out the functions described herein.

Wireless-communication interface 306 may include components such as one or more antennae, one or more chipsets designed and configured for one or more types of wireless communication (e.g., TETRA), and/or any other components deemed suitable by those of skill in the relevant art. Wireless-communication interface 306 may be configured to operate on two respectively different wireless networks (e.g., wireless network 102 and 104), though not necessarily simultaneously. For example, mobile radio 212 may operate on wireless network 102 at a first time using a first-wireless-network identifier, and may operate on wireless network 104 at a second time using a second-wireless-network identifier.

### IV. EXAMPLE WIRELESS-NETWORK IDENTIFIER

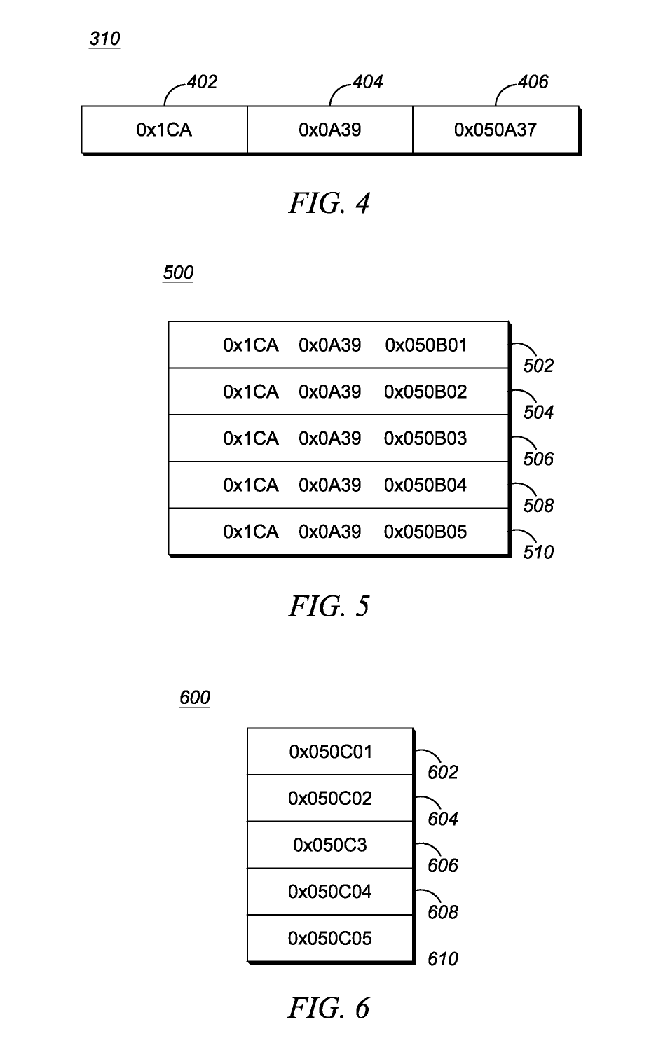

FIG. 4 depicts an example wireless-network identifier, in accordance with various embodiments. As shown in FIG. 4, identifier 310 may take the form of a number; the identifier could also take the form of a string of numbers, letters, symbols, and/or any combination of these, among other possibilities. Identifier 310 could be, for example, an Individual TETRA Subscriber Identity (ITSI), an Individual Short Subscriber Identity (ISSI), an International Mobile Subscriber Identity (IMSI), an Internet Protocol (IP) address, a Media Access Control (MAC) address, and/or a Network Access Identifier (NAI), among other possibilities. A given identifier may indicate one or more characteristics of mobile radio 212 to which the identifier is assigned—characteristics such as a type of the respective mobile radio 212, the manufacturer of mobile radio 212, the country in which mobile radio 212 was manufactured, and/or the wireless network to which mobile radio 212 is homed, among many other examples.

In an embodiment, identifier 310 includes a plurality of subparts 402, 404, and 406. The subparts could indicate respective characteristics of mobile radio 212. To illustrate by way of an example, each mobile radio that is capable of communicating via a TETRA network is generally assigned an Individual TETRA Subscriber Identity (ITSI) that is composed of three subparts: a Mobile Network Code (MNC), a Mobile Country Code (MCC), and an Individual Short Subscriber Identity (ISSI). The MNC identifies the wireless network to which mobile radio 212 is homed. The MCC identifies the country in which the homed network is located. The ISSI uniquely identifies mobile radio 212 with respect to all mobile radios sharing the given MNC.

In an embodiment, one or more identifiers (such as the identifiers in the second-wireless-network radio set) uniquely identify respective mobile radios on wireless network 104 but do not uniquely identify respective mobile radios beyond wireless network 104. For example, the second-wireless-network identifiers could take the form of respective ISSIs—without indicating a Mobile Network Code or Mobile Country Code. In another embodiment, the second-wireless-network identifiers in the second-wireless-network radio set could be respective subparts of respective internetwork identifiers that uniquely identify respective mobile radios beyond the wireless network 104. For example, the second-wireless-network identifiers could be ISSIs that are part of respective ITSIs. In still another embodiment, the second-wireless-network identifiers in the second-wireless-network radio set uniquely identify respective mobile radios both on wireless network 104 and beyond wireless network 104. For example, the second-wireless-network identifiers could take the form of respective ITSIs (which could include respective ISSIs). And certainly numerous other configurations are possible, as is known to those of skill in the relevant art.

### V. EXAMPLE RADIO SET

FIGS. 5 and 6 depict respective example radio sets of wireless-network identifiers, in accordance with various embodiments. As shown, radio set 500 includes a plurality of wireless-network identifiers 502 through 510, and radio set 600 includes a plurality of wireless-network identifiers 602 through 610. Either of the radio sets could take the form of an unordered set of identifiers, an ordered list of identifiers, and/or any combination of these, among other possibilities. As depicted in FIG. 5, the identifiers in the radio set could include multiple subparts (such as respective MNCs, MCCs, and/or ISSIs, as examples). Or, as depicted in FIG. 6, the identifiers may not include subparts, but instead may take the form (for example) of respective ISSIs. Other variations are possible as well.

### VI. EXAMPLE OPERATION

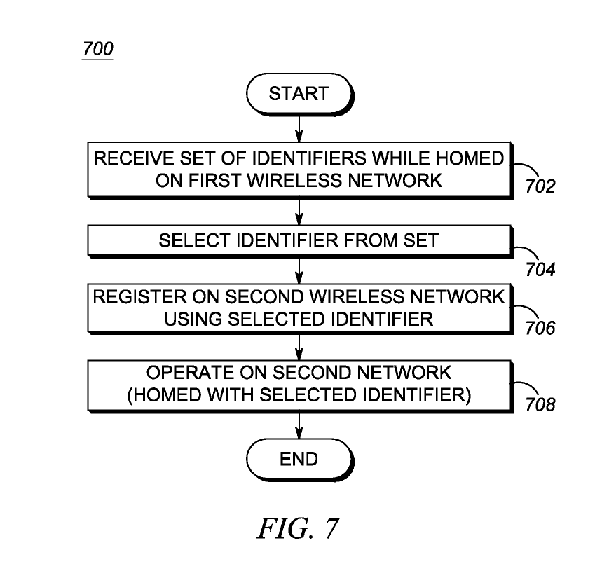

FIG. 7 is a flowchart of a method, in accordance with various embodiments. Though the method is described below as being carried out by mobile radio 212, those having skill in the art will appreciate that the method may be carried out by other entities as well.

As shown, method 700 begins at step 702 with mobile radio 212 receiving, while operating in a default mode, a second-wireless-network radio set of multiple second-wireless-network identifiers. In this description, identifiers that are operable to identify mobile radios homed on wireless network 102 are referred to as first-wireless-network identifiers, while identifiers that are operable to identify mobile radios homed on wireless network 104 are referred to as second-wireless-network identifiers. According to the default mode of operation, mobile radio 212 is homed on wireless network 102 in unique association on wireless network 102 with a given first-wireless-network identifier.

The second-wireless-network radio set is associated with wireless network 104 in at least the fact that the second-wireless-network radio set includes multiple second-wireless-network identifiers, and each second-wireless-network identifier in the second-wireless-network radio set is reserved for use on network 104 by mobile radios that are not homed on wireless network 104.

Wireless network 104 may require mobile radios attempting to register with the network to first attempt to register using a given identifier referred to as a control identifier. In an embodiment, prior to registering on wireless network 104 using the given second-wireless-network identifier, mobile radio 212 registers on wireless network 104 using a second-wireless-network control identifier. The control identifier could be included in the second-wireless-network radio set and/or could be included in another set of identifiers received by mobile radio 212 while mobile radio 212 is operating according to a default mode, among other possible implementations, as those having skill in the art will appreciate that other arrangements are possible as well.

The second-wireless-radio set may be received by the mobile radio 212 in a variety of manners. As one possibility, mobile radio 212 could receive the radio set via a short message service (SMS), a short data service (SDS) (the TETRA analog to SMS), and/or another type of message or data service, perhaps while it is operating in its homed wireless network 102. As another possibility, mobile radio 212 may receive the radio set via a provisioning process—for example, manually loaded onto the mobile radio 212 when mobile radio 212 is provided to an end user or over-the-air upon mobile radio 212 registering with network 102 (or possibly a different network).

As yet another possibility, mobile radio 212 could receive the radio set from a database server. The database server could take a form identical to or similar to database 206 described above (storing second-wireless-network identifiers and/or subscription profiles, as examples) and/or could take the form of a Home Location Register (HLR), a HSS (Home Subscriber Server), and/or a MME (Mobility Management Entity), among numerous other examples. And certainly there are other possible manners in which mobile radio 212 could receive the above-described radio set.

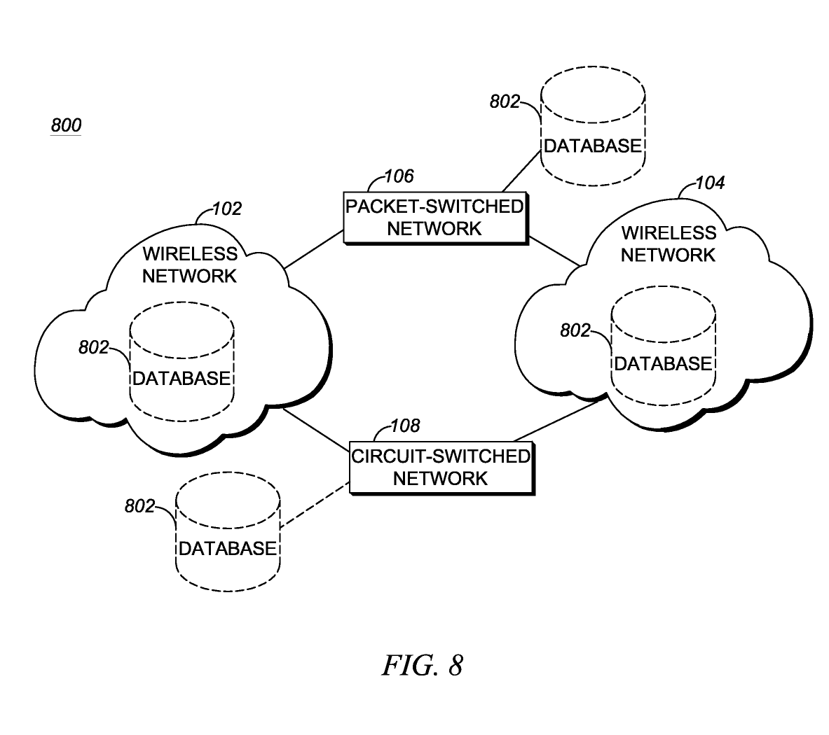

As illustrated in FIG. 8, a database server 802 (from which mobile radio 212 receives the above-described radio set) could be located in one or more points in a communication system 800. The database server could reside on wireless network 102, wireless network 104, or both wireless networks. Or the database server may reside on neither wireless network 102 nor wireless network 104—for example, the database server could reside on (or be communicatively linked to) packet-switched network 106 and/or circuit-switched network 108. As another possibility, one database server could reside on one or both of wireless networks 102 and 104, and another database service could reside on one or both of packet-switched network 106 and circuit-switched network 108, among other possibilities. Additionally, communication system 800 could (though needn't necessarily) take a form identical to or similar to communication system 100. Those having skill in the art will appreciate that other arrangements are possible as well.

At step 704, mobile radio 212 selects a given second-wireless-network identifier from among the multiple second-wireless-network identifiers in the second-wireless-network radio set that mobile radio 212 received at step 702. In an embodiment, the radio set takes the form of an ordered list of identifiers, and mobile radio 212 selects a given identifier from the list (e.g., the first identifier in the list).

In an embodiment, the given second-wireless-network identifier (that is selected by mobile radio 212 at step 704) is designated by the wireless network 102 as being reserved for mobile radio 212 as between the mobile radio and one or more other mobile radios that are also homed on the wireless network 102. In such an embodiment, wireless network 102 may be able to ensure that no two mobile radios attempt to register (e.g., simultaneously or nearly so) on wireless network 104 using the same second-wireless-network identifier.

At step 706, mobile radio 212 registers on wireless network 104 using the given second-wireless-network identifier (that is selected by mobile radio 212 at step 704), and at step 708, mobile radio 212 operates in a migrating mode of operation, according to which mobile radio 212 is homed on wireless network 104 in unique association on wireless network 104 with the given second-wireless-network identifier.

Registration using the second-wireless-network identifier may involve mobile radio 212 sending a registration request to network 104, the registration request including the given second-wireless-network identifier. Responsive to the unsuccessful attempt, the mobile radio 212 may then re-attempt registration using a different second-wireless-network identifier (e.g., the given second-wireless-network identifier).

In some instances, prior to registering on wireless network 104 using the given second-wireless-network identifier, mobile radio 212 unsuccessfully attempts to register on wireless network 104 using one or more second-wireless-network identifiers from the second-wireless-network radio set other than the given second-wireless-network identifier.

### VII. CONCLUSION

In the foregoing specification, specific embodiments have been described. However, one of ordinary skill in the art appreciates that various modifications and changes can be made without departing from the scope of the claims set forth below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as critical, required, or essential features or elements of any or all of the claims.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors (DSPs), customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all such functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, one or more embodiments can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. It is expected that one of ordinary skill, notwithstanding possibly significant effort and many design choices motivated by, for example, available time, current technology, and economic considerations, when guided by the concepts and principles disclosed herein will be readily capable of generating such instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This manner of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as separately claimed subject matter.

1. A method carried out by a mobile radio that has a default mode of operation according to which the mobile radio is homed on a first wireless network in unique association on the first wireless network with a first-wireless-network identifier, the method comprising:
receiving, while operating in the default mode, a second-wireless-network radio set of multiple second-wireless-network identifiers, the second-wireless-network radio set being associated with a second wireless network, each second-wireless-network identifier in the second-wireless-network radio set being reserved for use on the second wireless network by mobile radios that are not homed on the second wireless network;
selecting a given second-wireless-network identifier from among the multiple second-wireless-network identifiers in the second-wireless-network radio set;
registering on the second wireless network using the given second-wireless-network identifier; and
operating in a migrating mode of operation according to which the mobile radio is homed on the second wireless network in unique association on the second wireless network with the given second-wireless-network identifier.

2. The method of claim 1, wherein receiving the second-wireless-network radio set comprises receiving the second-wireless-network radio set via a provisioning process.

3. The method of claim 1, wherein receiving the second-wireless-network radio set comprises receiving the second-wireless-network radio set via at least one of a short message service (SMS) and a short data service (SDS).

4. The method of claim 1, wherein receiving the second-wireless-network radio set comprises receiving the second-wireless-network radio set from a database server.

5. The method of claim 4, wherein the database server resides on neither the first wireless network nor the second wireless network.

6. The method of claim 4, wherein the database server resides on the first wireless network.

7. The method of claim 4, wherein the database server resides on the second wireless network.

8. The method of claim 1, wherein the second-wireless-network radio set comprises a second-wireless-network control identifier, the method further comprising, prior to registering on the second wireless network using the given second-wireless-network identifier:
registering on the second wireless network using the second-wireless-network control identifier.

9. The method of claim 1, further comprising, prior to registering on the second wireless network using the given second-wireless-network identifier:
unsuccessfully attempting to register on the second wireless network using one or more second-wireless-network identifiers from the second-wireless-network radio set other than the given second-wireless-network identifier.

10. The method of claim 1, wherein the given second-wireless-network identifier is designated by the first wireless network as being reserved for the mobile radio as between the mobile radio and one or more other mobile radios that are also homed on the first wireless network.

11. The method of claim 1, wherein the first wireless network operates in a first country, and wherein the second wireless network operates in a second country.

12. The method of claim 1, wherein the second-wireless-network identifiers in the second-wireless-network radio set uniquely identify respective mobile radios on the second wireless network but do not uniquely identify respective mobile radios beyond the second wireless network.

13. The method of claim 12, wherein the second-wireless-network identifiers in the second-wireless-network radio set are respective subparts of respective internetwork identifiers that uniquely identify respective mobile radios beyond the second wireless network.

14. The method of claim 1, wherein the second-wireless-network identifiers in the second-wireless-network radio set uniquely identify respective mobile radios both on the second wireless network and beyond the second wireless network.

15. The method of claim 1, wherein each second-wireless-network identifier in the second-wireless-network radio set comprises a respective individual short subscriber identity (ISSI).

16. The method of claim 1, wherein each second-wireless-network identifier in the second-wireless-network radio set comprises a respective individual TErrestrial Trunked RAdio (TETRA) subscriber identity (ITSI).

17. The method of claim 1, wherein each second-wireless-network identifier in the second-wireless-network radio set comprises a respective international mobile subscriber identity (IMSI).

18. The method of claim 1, wherein each second-wireless-network identifier in the second-wireless-network radio set comprises a respective internet protocol (IP) address.

19. The method of claim 1, wherein each second-wireless-network identifier in the second-wireless-network radio set comprises a network access identifier (NAI).

20. A mobile radio that has a default mode of operation according to which the mobile radio is homed on a first wireless network in unique association on the first wireless network with a first-wireless-network identifier, the mobile radio comprising:
a wireless-communication interface;
a processor; and
data storage containing instructions executable by the processor for causing the mobile radio to carry out a set of functions, the set of functions including:
receiving, while operating in the default mode, a second-wireless-network radio set of multiple second-wireless-network identifiers, the second-wireless-network radio set being associated with a second wireless network, each second-wireless-network identifier in the second-wireless-network radio set being reserved for use on the second wireless network by mobile radios that are not homed on the second wireless network;
selecting a given second-wireless-network identifier from among the multiple second-wireless-network identifiers in the second-wireless-network radio set;
registering on the second wireless network using the given second-wireless-network identifier; and
operating in a migrating mode of operation according to which the mobile radio is homed on the second wireless network in unique association on the second wireless network with the given second-wireless-network identifier.
